(19) United States
(12) Patent Application Publication
(10) Pub. No.: US 2026/0003127 A1
(43) Pub. Date: Jan. 1, 2026

(54) OPTICAL PATH CONVERSION COMPONENT AND METHOD FOR MANUFACTURING OPTICAL PATH CONVERSION COMPONENT

(71) Applicant: SUMITOMO ELECTRIC INDUSTRIES, LTD., Osaka-shi (JP)

(72) Inventors: Hajime ARAO, Osaka (JP); Yasutaka MIZUNO, Osaka (JP)

(73) Assignee: SUMITOMO ELECTRIC INDUSTRIES, LTD., Osaka-shi (JP)

(21) Appl. No.: 19/218,879

(22) Filed: May 27, 2025

(30) Foreign Application Priority Data
Jun. 26, 2024 (JP) 2024-102682

(51) Int. Cl. G02B 6/32; G02B 6/36

(52) U.S. Cl. CPC G02B 6/322; G02B 6/3688

(57) ABSTRACT

An optical path conversion component includes a light-transmitting member; one or plurality of lenses; one or plurality of optical waveguides; and a formed part. The light-transmitting member has a first surface and a second surface that forms an angle of less than 90° with the first surface, and includes a region made of glass. The one or plurality of lenses are provided on the second surface. The one or plurality of optical waveguides are provided in the region, and are optically coupled to the one or plurality of lenses, respectively. The formed part is provided on the second surface, and contains a same constituent material as a constituent material of the one or plurality of lenses. The formed part has a surface parallel to any surface among outer surfaces of the light-transmitting member except for the second surface.

### CROSS REFERENCE

Priority is claimed on Japanese Patent Application No. 2024-102682, filed on Jun. 26, 2024, the entire content of which is incorporated herein by reference.

### TECHNICAL FIELD

The present disclosure relates to an optical path conversion component and a method for manufacturing an optical path conversion component.

### BACKGROUND

Japanese Unexamined Patent Publication No. 2020-79862 discloses an optical connector unit. The optical connector unit includes a holding member and an optical path conversion member. The holding member is made of glass, is fixed to a substrate including an input/output portion for inputting and outputting an optical signal, and holds an end portion of an optical fiber. The optical path conversion member includes a lens portion that reflects an optical signal while focusing the optical signal. An end surface of the optical fiber and an end surface of the holding member are obliquely polished. The optical path conversion member is fixed to the obliquely polished end surface of the optical fiber and the obliquely polished end surface of the holding member. The optical fiber is optically coupled to the input/output portion by converting the direction of an optical signal using the lens portion.

### SUMMARY

An optical path conversion component according to one embodiment of the present disclosure includes a light-transmitting member; one or plurality of lenses; one or plurality of optical waveguides; and a formed part. The light-transmitting member has a first surface and a second surface that forms an angle of less than 90° with the first surface, and includes a region made of glass. The one or plurality of lenses are provided on the second surface. The one or plurality of optical waveguides are provided in the region, and are optically coupled to the one or plurality of lenses, respectively. The formed part is provided on the second surface, and contains a same constituent material as a constituent material of the one or plurality of lenses. The formed part has a parallel surface parallel to any surface among outer surfaces of the light-transmitting member except for the second surface.

### BRIEF DESCRIPTION OF THE DRAWINGS

FIG. 1 is a view schematically illustrating a side cross-section of an optical system according to a first embodiment of the present disclosure.

FIG. 2 is a perspective view illustrating an optical path conversion component.

FIG. 3 is an enlarged perspective view illustrating a portion in the vicinity of a formed part of the optical path conversion component.

FIG. 4 is a side view illustrating a portion in the vicinity of the formed part of the optical path conversion component.

FIG. 5 is an enlarged perspective view illustrating the formed part.

FIG. 6 is a flowchart illustrating a method for manufacturing an optical path conversion component according to one embodiment.

FIG. 7 is a perspective view illustrating a part of an optical path conversion component according to one modification example.

FIG. 8 is a side view illustrating a part of the optical path conversion component.

FIG. 9A is a side cross-sectional view illustrating a lens according to another modification example.

FIG. 9B is a side cross-sectional view illustrating a formed part according to another modification example.

### DETAILED DESCRIPTION

An optical circuit substrate is a substrate for transmitting data using an optical signal rather than an electrical signal. A conventional electronic circuit substrate uses electricity to transmit a signal whereas the optical circuit substrate performs communication by transmitting light using an optical waveguide. The optical circuit substrate has various advantages such as high-speed transmission, low loss, reduced electromagnetic interference, and low power consumption, compared to the electronic circuit substrate.

For example, the optical circuit substrate is connected to an external optical waveguide such as an optical fiber, and inputs and outputs an optical signal. When the external optical waveguide is connected to the optical circuit substrate, for example, as in a structure described in Patent Literature 1, a component that holds the optical waveguide is provided with an inclined surface, and a reflective lens is provided on the inclined surface. Accordingly, the optical waveguide can be coupled to the optical circuit substrate.

However, in such a structure, it is not easy to align an optical axis of the lens with an optical axis of the optical waveguide. For example, the core of the optical fiber has an extremely small diameter such as 10 μm. Therefore, the reason is that the optical axis adjustment between the optical waveguide and the lens needs to be performed with extremely high accuracy, for example, with a deviation within 1 μm.

An object of the present disclosure is to provide an optical path conversion component capable of accurately aligning an optical axis of an optical waveguide with an optical axis of a lens, and a method for manufacturing an optical path conversion component.

### Description of Embodiment of Present Disclosure

First, the contents of an embodiment of the present disclosure will be listed and described. [1] An optical path conversion component according to the embodiment of the present disclosure includes: a light-transmitting member; one or plurality of lenses; one or plurality of optical waveguides; and a formed part. The light-transmitting member has a first surface and a second surface that forms an angle of less than 90° with the first surface, and includes a region made of glass. The one or plurality of lenses are provided on the second surface. The one or plurality of optical waveguides are provided in the region, and are optically coupled to the one or plurality of lenses, respectively. The formed part is provided on the second surface, and contains a same constituent material as a constituent material of the one or plurality of lenses. The formed part has a parallel surface parallel to any surface among outer surfaces of the light-transmitting member except for the second surface.

In the optical path conversion component of the above [1], the formed part is provided on the same second surface as the one or plurality of lenses, and contains the same constituent material as the constituent material of the one or plurality of lenses. Therefore, it is easy to form the formed part in the same process and using the same forming method as the one or plurality of lenses. Accordingly, the accuracy of the relative positions of the formed part and the one or plurality of lenses can be improved. Furthermore, the formed part has a parallel surface parallel to any surface among the outer surfaces of the light-transmitting member except for the second surface.

Accordingly, when irradiation is performed with a laser from any surface except for the second surface to form the optical waveguide, the parallel surface can be confirmed using, for example, a microscope, and the parallel surface can be used as a reference for the position of the optical waveguide. Therefore, according to the optical path conversion component of the above [1], an optical axis of each of the one or plurality of optical waveguides can be accurately aligned with an optical axis of each of the one or plurality of lenses.

[2] In the optical path conversion component according to the above [1], the formed part may be aligned with the one or plurality of lenses in a direction parallel to the first surface. In this case, the optical axis of each of the one or plurality of optical waveguides can be easily aligned with the optical axis of each of the one or plurality of lenses.

[3] In the optical path conversion component according to the above [1] or [2], the one or plurality of lenses and the formed part may be shaped by depressions formed on the second surface. In this case, the one or plurality of lenses and the formed part can be easily formed, for example, by etching. [4] In this case, the second surface may be made of glass.

[5] In the optical path conversion component according to the above [1] or [2], the one or plurality of lenses and the formed part may be made of resin. In this case, the one or plurality of lenses and the formed part can be easily formed, for example, by 3D nanoprinting.

[6] In the optical path conversion component according to the above [1] or [2], the light-transmitting member may include a first member and a second member. The first member is a member made of glass, forming the region, and having the first surface. The second member is fixed to the first member, and includes the second surface, the one or plurality of lenses, and the formed part. In this case, the first member in which the optical waveguides are formed and the second member in which the one or plurality of lenses and the formed part are formed can be formed as separate members.

[7] In the optical path conversion component according to the above [6], a constituent material of the second member may be different from a constituent material of the first member. In this case, since the constituent material of the second member is not limited to glass, the degree of freedom in selecting the material for the second surface can be increased.

[8] A method for manufacturing an optical path conversion component according to one embodiment of the present disclosure is a method for manufacturing the optical path conversion component according to the above [1] or [2], includes: forming the one or plurality of lenses and the formed part in a same process and using a same forming method; and forming the one or plurality of optical waveguides while using the parallel surface of the formed part as a positional reference.

The formed part is provided on the same second surface as the one or plurality of lenses, and contains the same constituent material as the constituent material of the one or plurality of lenses. Therefore, it is easy to form the formed part in the same process and using the same forming method as the one or plurality of lenses. Accordingly, the accuracy of the relative positions of the formed part and the one or plurality of lenses can be improved. Furthermore, the formed part has a parallel surface parallel to any surface among the outer surfaces of the light-transmitting member except for the second surface. Accordingly, when irradiation is performed with a laser from any surface except for the second surface to form the optical waveguide, the parallel surface can be confirmed using, for example, a microscope, and the parallel surface can be used as a reference for the position of the optical waveguide. Therefore, according to the manufacturing method of the above [8], the optical axis of each of the one or plurality of optical waveguides can be accurately aligned with the optical axis of each of the one or plurality of lenses.

[9] In the method for manufacturing the optical path conversion component according to the above [8], in the forming the one or plurality of optical waveguides, the region may be irradiated with a laser beam for forming focal points in the region to form the one or plurality of optical waveguides. In this case, the one or plurality of optical waveguides can be easily formed while using the parallel surface as a positional reference.

### Details of Embodiment of Present Disclosure

Specific examples of the present disclosure will be described below with reference to the drawings. The present disclosure is not limited to the examples, but is defined by the claims, and it is intended that the present disclosure includes all modifications within the concept and scope equivalent to the claims. In the following description, the same elements in the description of the drawings are denoted by the same reference signs, and duplicate descriptions will be omitted.

### First Embodiment

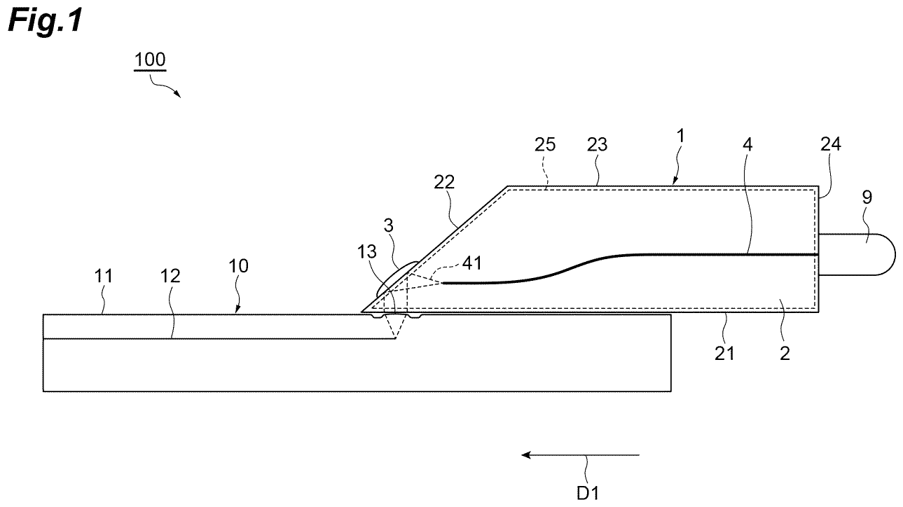

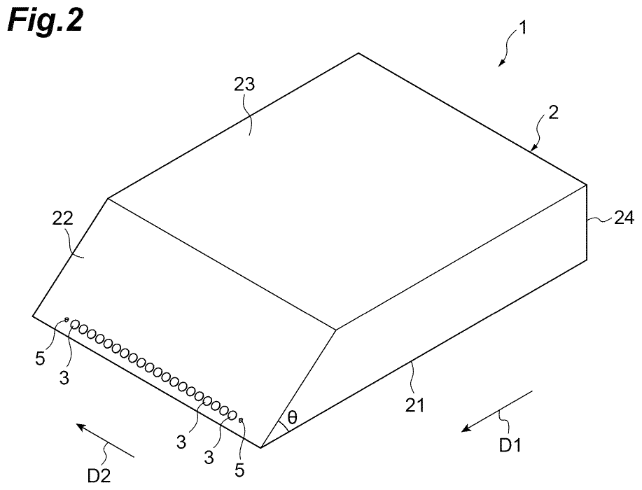

FIG. 1 is a view schematically illustrating a side cross-section of an optical system 100 according to a first embodiment of the present disclosure. FIG. 2 is a perspective view illustrating an optical path conversion component 1. As illustrated in FIG. 1, the optical system 100 includes the optical path conversion component 1 and an optical integrated circuit substrate 10. The optical path conversion component 1 is mounted on the optical integrated circuit substrate 10.

FIG. 2 is a perspective view illustrating the optical path conversion component 1. As illustrated in FIGS. 1 and 2, the optical path conversion component 1 includes a light-transmitting member 2, a plurality of reflective lenses 3, a plurality of optical waveguides 4, two formed parts 5 (refer to FIG. 2), and two guide pins 9. In FIG. 2, the illustration of the guide pins 9 is omitted.

The light-transmitting member 2 has a substantially plate shape, and has a first surface 21, a second surface 22, a third surface 23, and a fourth surface 24. The first surface 21, the second surface 22, the third surface 23, and the fourth surface 24 are, for example, flat and smooth surfaces. The first surface 21 faces the optical integrated circuit substrate 10, and in one example, is bonded to the optical integrated circuit substrate 10. The first surface 21 has the largest area among the plurality of flat surfaces forming outer surfaces of the light-transmitting member 2. The third surface 23 is a surface facing opposite to the first surface 21. The third surface 23 may be parallel to the first surface 21. The normal line to the first surface 21 and the third surface 23 is aligned along a thickness direction of the light-transmitting member 2 having a plate shape. In a plan view, the first surface 21 and the third surface 23 have, for example, a square shape or a rectangular shape. The second surface 22 connects the first surface 21 and the third surface 23. The second surface 22 is inclined with respect to an imaginary plane parallel to the first surface 21, and forms an angle θ of less than 90° with the first surface 21. The angle θ is, for example, 30 degrees or more and 45 degrees or less, and in one example, is 41 degrees. The fourth surface 24 is aligned with the second surface 22 in a certain direction D1 along the first surface 21 and the third surface 23. The fourth surface 24 may or may not be inclined with respect to an imaginary plane parallel to the first surface 21. In the illustrated example, the fourth surface 24 is perpendicular to an imaginary plane parallel to the first surface 21, and forms 90° with the first surface 21. The second surface 22 is a first end surface of the light-transmitting member 2 in the direction D1, and the fourth surface 24 is a second end surface of the light-transmitting member 2 in the direction D1.

The light-transmitting member 2 includes a region 25 made of glass (refer to FIG. 1). In the illustrated example, the entirety of the light-transmitting member 2 is the region 25. Therefore, the first surface 21, the second surface 22, the third surface 23, and the fourth surface 24 are included in the region 25. The glass material of the region 25 is, for example, quartz glass, non-alkali glass (for example, EAGLE XG (registered trademark)), or borosilicate glass (for example, TEMPAX Float (registered trademark)). The region 25 is not limited to this example, and may be made of glass only in a part of the light-transmitting member 2.

The plurality of lenses 3 are provided on the second surface 22. The plurality of lenses 3 have a convex shape on the second surface 22 which faces the outside of the light-transmitting member 2. The plurality of lenses 3 are aligned in a row along the first surface 21 and in a direction D2 intersecting the direction D1. The plurality of lenses 3 are not limited to this example, and may be provided in a plurality of rows with each row aligned along the direction D2. Each of the plurality of lenses 3 is formed by a technique, for example, 3D nanoprinting. The constituent material of the plurality of lenses 3 may be the same as the constituent material of the light-transmitting member 2, or may be different. The constituent material of the plurality of lenses 3 is, for example, resin.

The plurality of optical waveguides 4 are provided in the region 25, and are optically coupled to the plurality of lenses 3, respectively. Each of the plurality of optical waveguides 4 is formed, for example, by allowing a laser beam having an extremely short pulse width on the order of femtosecond to be incident on the region 25 from the first surface 21 (or the third surface 23), and moving a focal point in the region 25 in an optical waveguide direction while focusing the laser beam at the focal point. A first end of each of the plurality of optical waveguides 4 is located in a region far from the fourth surface 24 and close to the second surface 22. However, the respective first ends of the plurality of optical waveguides 4 do not reach the second surface 22, and are provided at predetermined spacings between the lenses 3 provided on the second surface 22 and the corresponding optical waveguides 4.

A second end of each of the plurality of optical waveguides 4 is located in a region far from the second surface 22 and close to the fourth surface 24. In the illustrated example, the second end of each of the plurality of optical waveguides 4 reaches the fourth surface 24. A ferrule of an optical connector (not illustrated) including the ferrule holding a plurality of optical fibers comes into contact with the fourth surface 24. The second end of each of the plurality of optical waveguides 4 is optically coupled to a corresponding optical fiber among the plurality of optical fibers.

The two guide pins 9 protrude from the fourth surface 24. The two guide pins 9 are fitted into two guide pin holes formed in the ferrule of the optical connector, respectively. Accordingly, each of the plurality of optical fibers of the optical connector is accurately aligned with each of the optical waveguides 4.

The two formed parts 5 are provided on the second surface 22. The two formed parts 5 are aligned with the plurality of lenses 3 in the direction D2 parallel to the first surface 21. In the illustrated example, the two formed parts 5 are provided at positions sandwiching a lens row including only the plurality of lenses 3 from both sides in the direction D2. In other words, when viewed along the direction D2, the two formed parts 5 overlap the plurality of lenses 3.

Each of the formed parts 5 contains the same constituent material as the constituent material of the plurality of lenses 3. When the plurality of lenses 3 are made of resin, the formed parts 5 are also made of resin. Each of the formed parts 5 is formed in the same process and by the same forming method as the plurality of lenses 3. For example, when the plurality of lenses 3 are formed by 3D nanoprinting, each of the formed parts 5 is also formed by 3D nanoprinting.

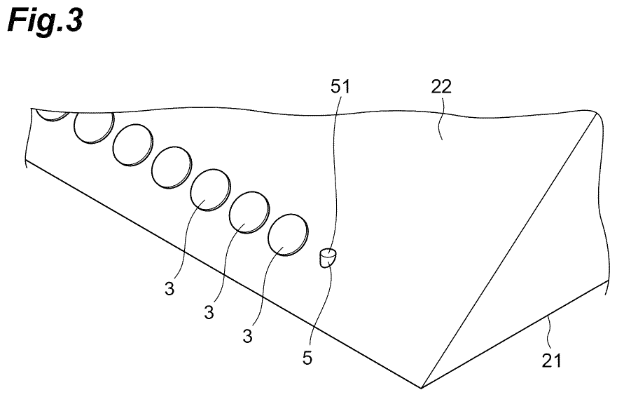

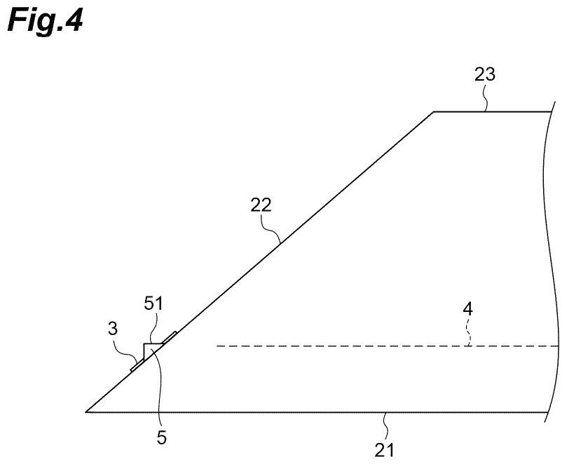

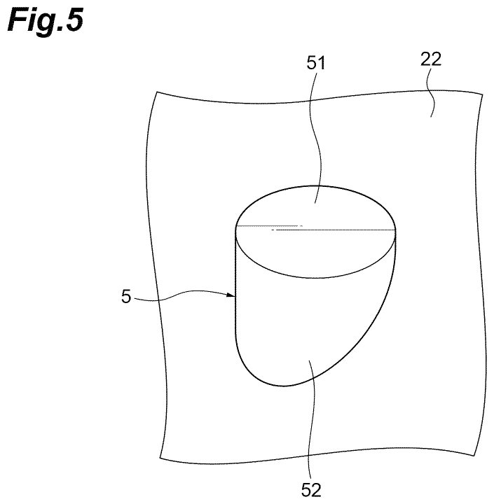

FIG. 3 is an enlarged perspective view illustrating a portion in the vicinity of the formed part 5 of the optical path conversion component 1. FIG. 4 is a side view illustrating a portion in the vicinity of the formed part 5 of the optical path conversion component 1. FIG. 5 is an enlarged perspective view illustrating the formed part 5. As illustrated in these figures, the formed part 5 has a protruding shape which faces the outside of the light-transmitting member 2 on the second surface 22.

The formed part 5 has a surface 51 and a surface 52. The surface 51 is a flat surface. When a laser beam is focused in the region 25 to form the optical waveguide 4, the edge of the surface 51 serves as a reference for a focal position (namely, the position of the optical waveguide 4). The surface 51 is parallel to any surface among the outer surfaces of the light-transmitting member 2 except for the second surface 22, namely, a surface with which the laser beam is irradiated. In the present embodiment, since the first surface 21 or the third surface 23 is irradiated with the laser beam, the surface 51 is parallel to the first surface 21 and the third surface 23. The surface 51 may have a circular shape, an elliptical shape, a rectangular shape, or a polygonal shape. When the shape of the surface 51 is a circular shape, a diameter of the surface 51 is, for example, 20 μm or more and 200 μm or less. The surface 52 is continuous from the surface 51 toward the first surface 21. The shape of the surface 52 in a cross-section parallel to the first surface 21 may coincide with the shape of the surface 51 or may not coincide therewith. For example, when the shape of the surface 51 is a circular shape, the surface 52 may be a columnar surface or may have a shape other than a columnar surface.

Referring again to FIG. 1, the optical integrated circuit substrate 10 includes a main surface 11, a plurality of optical waveguides 12, and a plurality of lenses 13. The main surface 11 faces the first surface 21 of the light-transmitting member 2, and in one example, is bonded to the first surface 21. The plurality of optical waveguides 12 are embedded inside the optical integrated circuit substrate 10, and extend along the main surface 11. The first end of each of the plurality of optical waveguides 12 is located directly below each of the plurality of lenses 3. The plurality of lenses 13 are formed on the main surface 11. The first end of each of the optical waveguides 12 is optically coupled to each of the plurality of lenses 3 via each of plurality of lenses 13. A grating coupler may be provided at the first end of each of the plurality of optical waveguides 12.

Light 41 that has propagated through the optical waveguide 4 is emitted from the first end of the optical waveguide 4, and then reaches the lens 3 while diverging. The light 41 is reflected toward the first surface 21 while being collimated by the lens 3. The light 41 transmits through the first surface 21, and is incident on the optical integrated circuit substrate 10. Alternatively, the light 41 emitted from the optical integrated circuit substrate 10 is incident on the first surface 21 of the light-transmitting member 2 along the thickness direction of the light-transmitting member 2. The light 41 is reflected toward the first end of the optical waveguide 4 while being focused by the lens 3. The light 41 is incident on the first end of the optical waveguide 4.

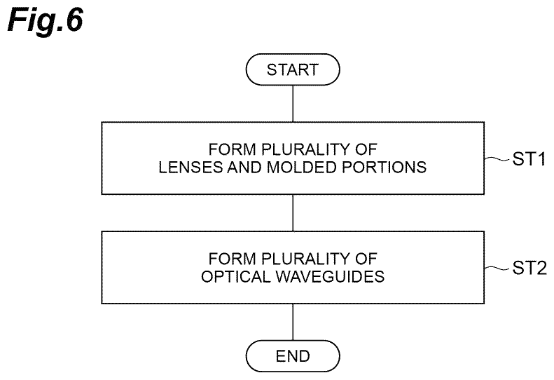

FIG. 6 is a flowchart illustrating a method for manufacturing the optical path conversion component 1 according to one embodiment. As illustrated in FIG. 6, the method for manufacturing the optical path conversion component 1 of the present embodiment includes a first step ST1 and a second step ST2. In the first step ST1, the plurality of lenses 3 and the formed parts 5 are formed in the same process and by the same forming method. In the second step ST2, the plurality of optical waveguides 4 are formed while using the surfaces 51 of the formed parts 5 as a positional reference. In the second step ST2, the region 25 is irradiated with a laser beam for forming a focal point in the region 25, and the focal point is moved (scanned) along the optical waveguide direction while focusing the laser beam. Accordingly, the plurality of optical waveguides 4 are formed by repeating such a process for the number of the optical waveguides. A wavelength of the laser beam is, for example, 500 nm or more and 550 nm or less, 750 nm or more and 850 nm or less, or 1000 nm or more and 1100 nm or less. A pulse width of the laser beam is, for example, 50 fs or more and 500 fs or less. An average power of the laser beam is, for example, 10 mW or more and 500 mW or less. The position of the surface 51 in the thickness direction of the light-transmitting member 2 (in other words, a light irradiation direction) can be confirmed by aligning the focus of a microscope, which is used when irradiation is performed with the laser beam, with the surface 51.

Effects obtained by the optical path conversion component 1 and the method for manufacturing an optical path conversion component of the present embodiment described above will be described. In the optical path conversion component 1 and the method for manufacturing an optical path conversion component of the present embodiment, the formed parts 5 are provided on the same second surface 22 as the plurality of lenses 3, and contain the same constituent material as the constituent material of the plurality of lenses 3. Therefore, it is easy to form the formed parts 5 in the same process and using the same forming method as the plurality of lenses 3. Accordingly, the accuracy of the relative positions of the formed parts 5 and the plurality of lenses 3 can be improved. Furthermore, each of the formed parts 5 has the surface 51 parallel to any surface among the outer surfaces of the light-transmitting member 2 except for the second surface 22. Accordingly, when irradiation is performed with a laser beam from a plane parallel to the surface 51 to form the optical waveguide 4, the surface 51 can be confirmed using, for example, a microscope, and the surface 51 can be used as a reference for the position of the optical waveguide 4. Therefore, according to the optical path conversion component 1 and the method for manufacturing the optical path conversion component 1 of the present embodiment, an optical axis of each of the plurality of optical waveguides 4 can be accurately aligned with an optical axis of each of the plurality of lenses 3.

As in the present embodiment, the formed parts 5 may be aligned with the plurality of lenses 3 in the direction D2 parallel to the first surface 21. In this case, the optical axis of each of the plurality of optical waveguides 4 can be easily aligned with the optical axis of each of the plurality of lenses 3.

As in the present embodiment, the plurality of lenses 3 and the formed parts 5 may be made of resin. In this case, the plurality of lenses 3 and the formed parts 5 can be easily formed, for example, by 3D nanoprinting.

As in the present embodiment, in the second process ST2, the region 25 is irradiated with a laser beam for forming focal points in the region 25 to form the plurality of optical waveguides 4. In this case, the plurality of optical waveguides 4 can be easily formed while using the surfaces 51 as a positional reference.

### First Modification Example

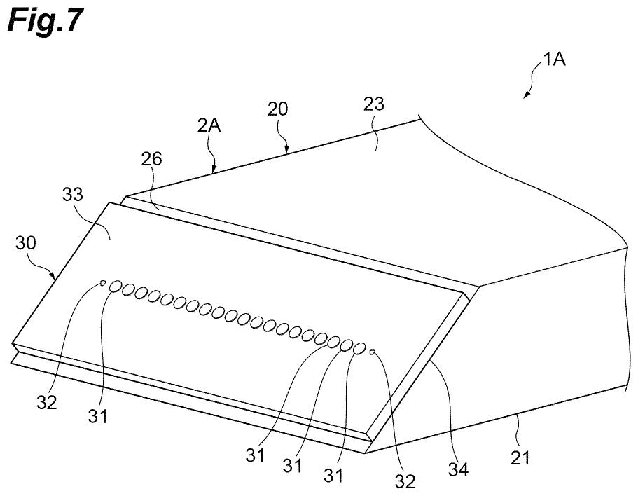

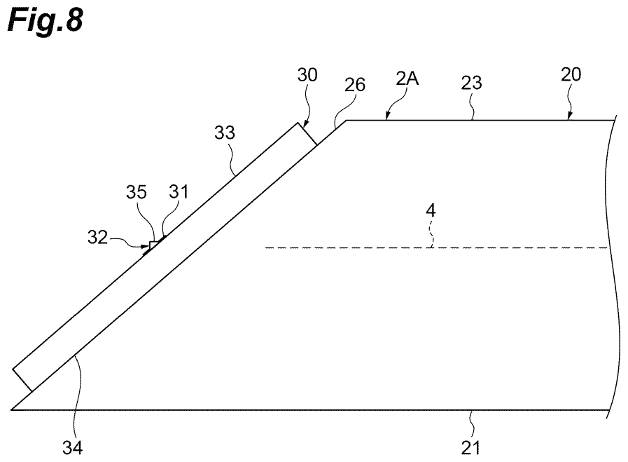

FIG. 7 is a perspective view illustrating a part of an optical path conversion component 1A according to one modification example of the above-described embodiment. FIG. 8 is a side view illustrating a part of the optical path conversion component 1A. As illustrated in these figures, the optical path conversion component 1A includes a light-transmitting member 2A instead of the light-transmitting member 2 of the above-described embodiment. The light-transmitting member 2A includes a first member 20 and a second member (microlens array) 30. Similarly to the light-transmitting member 2 of the above-described embodiment, the first member 20 has the first surface 21, the third surface 23, and the fourth surface 24. Furthermore, the first member 20 has a surface 26 instead of the second surface 22 of the above-described embodiment.

The constituent material of the second member 30 is different from the constituent material of the first member 20, and is, for example, resin. The second member 30 is fixed to the first member 20. The second member 30 is a light-transmitting property, and is disposed on the surface 26 of the first member 20. The second member 30 is a plate-shaped member, and has a main surface 33 and a back surface 34. The back surface 34 of the second member 30 faces the surface 26 of the first member 20, and is bonded to the surface 26. The main surface 33 of the second member 30 is a second surface of the light-transmitting member 2A. The main surface 33 is inclined with respect to an imaginary plane parallel to the first surface 21, and forms an angle of less than 90° with the first surface 21. The magnitude of this angle is the same as that of the angle θ in the above-described embodiment. A plurality of lenses 31 and two formed parts 32 are formed on the main surface 33. The disposition and shape of the plurality of lenses 31 and the two formed parts 32 are the same as the disposition and shape of the plurality of lenses 3 and the two formed parts 5 in the above-described embodiment. However, the plurality of lenses 31 and the two formed parts 32 are molded as a single component with the second member 30 on the main surface 33.

As in the present modification example, the light-transmitting member 2A may include the first member 20 and the second member 30. The first member 20 is a member made of glass, forming the region 25, and having the first surface 21. The second member 30 is fixed to the first member 20, and has the main surface 33 (second surface), the plurality of lenses 31, and the formed parts 32. In this case, the first member 20 in which the optical waveguides 4 are formed and the second member 30 in which the plurality of lenses 31 and the formed parts 32 are formed can be formed as separate members.

As described above, the constituent material of the second member 30 may be different from the constituent material of the first member 20. In this case, since the constituent material of the second member 30 is not limited to glass, the degree of freedom in selecting the material for the main surface 33 (second surface) on which the plurality of lenses 31 and the formed parts 32 are provided can be increased.

### Second Modification Example

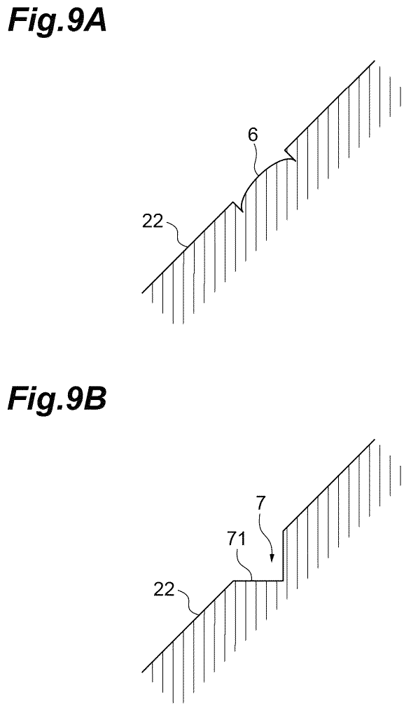

FIGS. 9A and 9B are side cross-sectional views illustrating one lens 6 among a plurality of the lenses 6 and one of two formed parts 7, respectively, according to another modification example of the above-described embodiment. The disposition and function of the plurality of lenses 6 and the two formed parts 7 are the same as the disposition and function of the plurality of lenses 3 and the two formed parts 5 in the above-described embodiment. The formed parts 7 have surfaces 71 having the same shape as the surfaces 51 of the formed parts 5 of the above-described embodiment.

As illustrated in FIG. 9A, the plurality of lenses 6 of the optical path conversion component are shaped by depressions formed on the second surface 22. Similarly, as illustrated in FIG. 9B, the two formed parts 7 of the optical path conversion component are shaped by depressions formed on the second surface 22. In this case, the plurality of lenses 6 and the two formed parts 7 can be easily formed, for example, by etching. The second surface 22 can be made of various materials that can be etched, and in one example, is made of glass.

The optical path conversion component and the method for manufacturing an optical path conversion component according to the present disclosure are not limited to the above-described embodiment, and can be modified in various modes. For example, in the above-described embodiment and each modification example, the optical path conversion component includes a plurality of optical waveguides and a plurality of lenses; however, the optical path conversion component may include a single optical waveguide and a single lens. Even in such a case, the effects of the above-described embodiment and each modification example can be achieved. In the above-described embodiment and each modification example, the optical path conversion component includes two formed parts; however, the number of the formed parts is not limited thereto.

What is claimed is:

1. An optical path conversion component, comprising:
a light-transmitting member having a first surface and a second surface that forms an angle of less than 90° with the first surface, and including a region made of glass;
one or plurality of lenses provided on the second surface;
one or plurality of optical waveguides provided in the region, and optically coupled to the one or plurality of lenses, respectively; and
a formed part provided on the second surface, and containing a same constituent material as a constituent material of the one or plurality of lenses;
wherein the formed part has a parallel surface parallel to any surface among outer surfaces of the light-transmitting member except for the second surface.

2. The optical path conversion component according to claim 1,
wherein the formed part is aligned with the one or plurality of lenses in a direction parallel to the first surface.

3. The optical path conversion component according to claim 1,
wherein the one or plurality of lenses and the formed part are shaped by depressions formed on the second surface.

4. The optical path conversion component according to claim 3,
wherein the second surface is made of glass.

5. The optical path conversion component according to claim 1,
wherein the one or plurality of lenses and the formed part are made of resin.

6. The optical path conversion component according to claim 1,
wherein the light-transmitting member includes a first member made of glass, forming the region, and having the first surface, and a second member fixed to the first member and including the second surface, the one or plurality of lenses, and the formed part.

7. The optical path conversion component according to claim 6,
wherein a constituent material of the second member is different from a constituent material of the first member.

8. A method for manufacturing the optical path conversion component according to claim 1, comprising:
forming the one or plurality of lenses and the formed part in a same process and using a same forming method; and
forming the one or plurality of optical waveguides while using the parallel surface of the formed part as a positional reference.

9. The method for manufacturing the optical path conversion component according to claim 8,
wherein in the forming the one or plurality of optical waveguides, the region is irradiated with a laser beam for forming focal points in the region to form the one or plurality of optical waveguides.
